(19) United States
(12) Patent Application Publication
(10) Pub. No.: US 2014/0250384 A1
(43) Pub. Date: Sep. 4, 2014

(54) Remotely Navigating A Display of a Target Computing Device Using A Screen of a Source Computing Device

(71) Applicant: MICROSOFT CORPORATION, Redmond, WA (US)

(72) Inventors: Jason Van Eaton, Bothell, WA (US); Jared J. Jackson, Sammamish, WA (US)

(73) Assignee: MICROSOFT CORPORATION, Redmond, WA (US)

(21) Appl. No.: 13/781,935

(22) Filed: Mar. 1, 2013

(51) Int. Cl. G06F 3/0484

(52) U.S. Cl. CPC G06F 3/0484
USPC 715/740

(57) ABSTRACT

A method and system for remotely navigating a display of a target computing device using a screen of a source computing device are provided herein. The method includes detecting a source input on the screen, determining the positions of a number of navigation jump points on the screen, and determining whether the source input is associated with a navigation jump point. If the source input is not associated with a navigation jump point, relative pixel mapping is performed to translate the source input into a corresponding target input on the display. Alternatively, if the source input is associated with a navigation jump point, absolute pixel mapping is performed to translate the source input into a corresponding target input on the display, and relative pixel mapping is performed to translate any continuation of the source input into a corresponding continuation of the target input.

### BACKGROUND

In some cases, it may be desirable to use a screen of a source computing device, such as a touchscreen or other type of screen that utilizes a pen or mouse for navigation, to remotely navigate a display of a target computing device. However, the screen of the source computing device may be much smaller than the display of the target computing device. Therefore, it may be difficult to elegantly map the screen to the display while still maintaining pixel for pixel accuracy. For example, consider the case of using a mobile phone including a touchscreen with a resolution of 600 by 400 pixels to remotely control a desktop computer including a monitor with a resolution of 3,000 by 2,000 pixels. In other words, for every one pixel on the touchscreen of the mobile phone, there are five pixels on the monitor of the remotely controlled desktop computer. If relative, e.g., 1:1, pixel mapping is used to move the mouse on the monitor of the desktop computer from the far left to the far right (or from the top to the bottom), the user will have to swipe his finger across the touchscreen of the mobile phone five times. On the other hand, if absolute, e.g., 1:5, pixel mapping is used to move the mouse on the monitor of the desktop computer from the far left to the far right (or from the top to the bottom), the user will only have to swipe his finger across the touchscreen of the mobile phone one time. However, pixel for pixel accuracy is not maintained for absolute pixel mapping, since every pixel on the touchscreen of the mobile phone corresponds to five pixels on the monitor of the desktop computer.

### SUMMARY

The following presents a simplified summary of the subject innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

An embodiment provides a method for remotely navigating a display of a target computing device using a screen of a source computing device. The method includes detecting a source input on a screen of a source computing device, determining a position of each of a number of navigation jump points on the screen, and determining whether the source input is associated with a navigation jump point. If the source input is not associated with a navigation jump point, the method includes performing relative pixel mapping to translate the source input on the screen into a corresponding target input on a display of a target computing device. Alternatively, if the source input is associated with a navigation jump point, the method includes performing absolute pixel mapping to translate the source input into a corresponding target input on the display based on the navigation jump point with which the source input is associated, and performing relative pixel mapping to translate any continuation of the source input on the screen into a corresponding continuation of the target input on the display.

Another embodiment provides a system for remotely navigating a display of a target computing device using a screen of a source computing device. The system includes a target computing device including a display and a network for communicably coupling the target computing device to a source computing device. The system also includes the source computing device, which includes a screen. The screen includes a number of navigation jump points. The source computing device also includes a processor that is adapted to execute stored instructions and a system memory. The system memory includes code configured to detect a source input on the screen and determine whether the source input is associated with a navigation jump point based on a position at which the source input is applied to the screen. The system memory also includes code configured to perform relative pixel mapping to translate the source input on the screen into a corresponding target input on the display of the target computing device if the source input is not associated with a navigation jump point. Further, the system memory includes code configured to perform absolute pixel mapping to translate the source input on the screen into a corresponding target input on the display based on the navigation jump point with which the source input is associated, as well as perform relative pixel mapping to translate any continuation of the source input on the screen into a corresponding continuation of the target input on the display, if the source input is associated with a navigation jump point.

In addition, another embodiment provides one or more computer-readable storage media for storing computer-readable instructions. The computer-readable instructions provide a system for remotely navigating a display of a target computing device using a screen of a source computing device when executed by one or more processing devices. The computer-readable instructions include code configured to detect a source input sent from the source computing device to the target computing device via a network, determine a position of each of a number of navigation jump points on the screen of the source computing device, and determine whether the source input is associated with a navigation jump point based on a position at which the source input is applied to the screen. The computer-readable instructions also include code configured to perform relative pixel mapping to translate the source input on the screen into a corresponding target input on the display of the target computing device if the source input is not associated with a navigation jump point. Furthermore, the computer-readable instructions include code configured to perform absolute pixel mapping to translate the source input on the screen into a corresponding target input on the display based on the navigation jump point with which the source input is associated, as well as perform relative pixel mapping to translate any continuation of the source input on the screen into a corresponding continuation of the target input on the display, if the source input is associated with a navigation jump point.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a networking environment in which a system and method for remotely navigating a display of a target computing device using a screen of a source computing device may be implemented;

FIG. 2 is a block diagram of a computing environment that may be used to implement a system and method for remotely navigating a display of a target computing device using a screen of a source computing device;

FIG. 3 is a block diagram of a system for remotely navigating a display of a target computing device using a screen of a source computing device;

FIG. 4 is a schematic of a mobile phone including a touchscreen that may be used to remotely navigate a display of a target computing device;

FIG. 5 is a process flow diagram of a method for translating a source input on a screen of a source computing device into an input to be applied to a display of a target computing device; and

FIG. 6 is a process flow diagram of a method for remotely navigating a display of a target computing device using a screen of a source computing device.

### DETAILED DESCRIPTION

As discussed above, it may be desirable to allow a user to remotely navigate a display, e.g., a monitor or touchscreen, of a target computing device using a screen, e.g., a touchscreen or other type of screen that utilizes a pen, stylus, mouse, or the like for navigation, of a source computing device. However, the screen of the source computing device may be much smaller than the display of the target computing device. Therefore, it may be difficult to elegantly map the screen to the display while still maintaining pixel for pixel accuracy. Accordingly, embodiments described herein provide for the remote navigation of a display of a target computing device using a screen of a source computing device based on a combination of absolute pixel mapping and relative pixel mapping. More specifically, a number of navigation jump points positioned on the screen of the source computing device may be used to provide a combination of absolute pixel mapping and relative pixel mapping for remotely navigating the display of the target computing device using the screen of the source computing device.

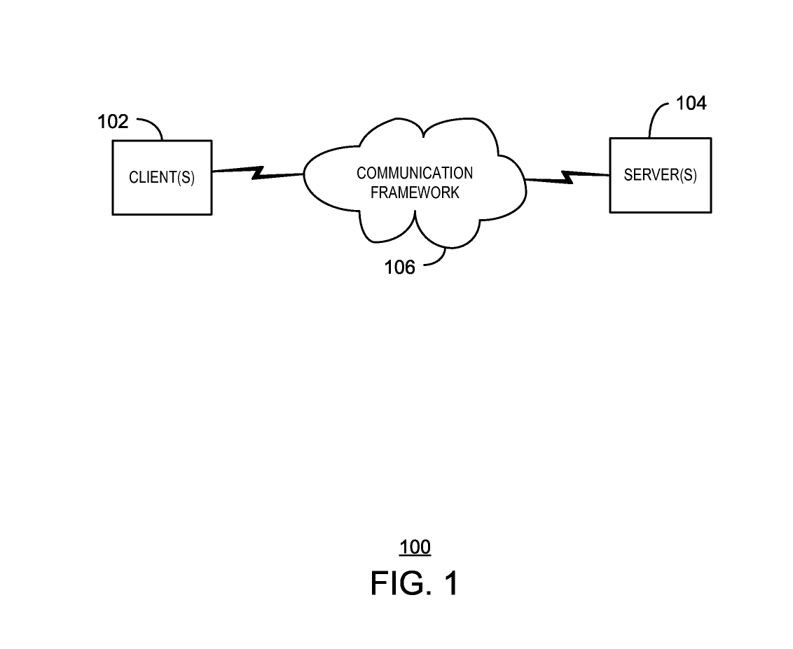

As a preliminary matter, some of the figures describe concepts in the context of one or more structural components, variously referred to as functionality, modules, features, elements, or the like. The various components shown in the figures can be implemented in any manner, such as via software, hardware (e.g., discrete logic components), firmware, or any combinations thereof. In some embodiments, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like.

The term “logic” encompasses any functionality for performing a task. For instance, each operation illustrated in the flowcharts corresponds to logic for performing that operation. An operation can be performed using, for instance, software, hardware, firmware, or the like.

As used herein, the terms “component,” “system,” “client,” “search engine,” “browser,” “server,” and the like are intended to refer to a computer-related entity, either hardware, software (e.g., in execution), or firmware, or any combination thereof. For example, a component can be a process running on a processor, an object, an executable, a program, a function, a library, a subroutine, a computer, or a combination of software and hardware.

By way of illustration, both an application running on a server and the server can be a component. One or more components can reside within a process, and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable storage device or media.

Computer-readable storage media can include but are not limited to magnetic storage devices (e.g., hard disk, floppy disk, and magnetic strips, among others), optical disks (e.g., compact disk (CD) and digital versatile disk (DVD), among others), smart cards, and flash memory devices (e.g., card, stick, and key drive, among others). In contrast, computer-readable media (i.e., not storage media) generally may additionally include communication media such as transmission media for wireless signals and the like.

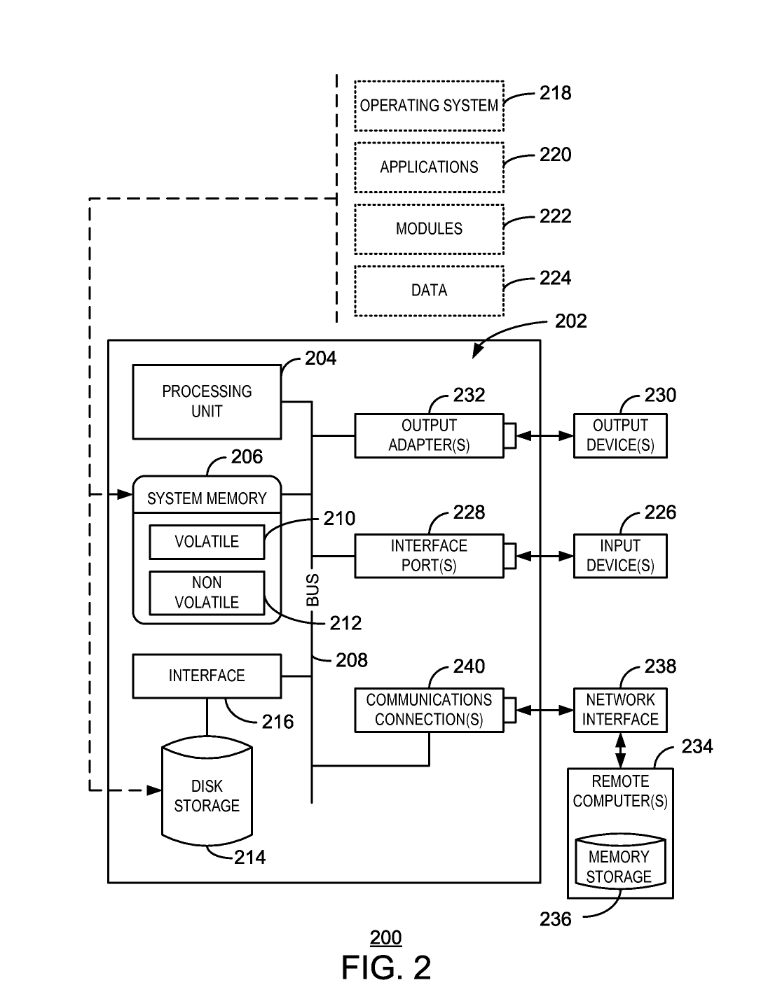

In order to provide context for implementing various aspects of the claimed subject matter, FIGS. 1-2 and the following discussion are intended to provide a brief, general description of a computing environment in which the various aspects of the subject innovation may be implemented. For example, a method and system for remotely navigating a display of a target computing device using a screen of a source computing device can be implemented in such a computing environment. While the claimed subject matter has been described above in the general context of computer-executable instructions of a computer program that runs on a local computer or remote computer, those of skill in the art will recognize that the subject innovation also may be implemented in combination with other program modules. Generally, program modules include routines, programs, components, data structures, or the like that perform particular tasks or implement particular abstract data types.

Moreover, those of skill in the art will appreciate that the subject innovation may be practiced with other computer system configurations. For example, the subject innovation may be practiced with single-processor or multi-processor computer systems, minicomputers, mainframe computers, personal computers, hand-held computing systems, microprocessor-based or programmable consumer electronics, or the like, each of which may operatively communicate with one or more associated devices. The illustrated aspects of the claimed subject matter may also be practiced in distributed computing environments wherein certain tasks are performed by remote processing devices that are linked through a communications network. However, some, if not all, aspects of the subject innovation may be practiced on stand-alone computers. In a distributed computing environment, program modules may be located in local or remote memory storage devices.

FIG. 1 is a block diagram of a networking environment 100 in which a system and method for remotely navigating a display of a target computing device using a screen of a source computing device may be implemented. The networking environment 100 includes one or more client(s) 102. The client(s) 102 can be hardware and/or software (e.g., threads, processes, or computing systems). The networking environment 100 also includes one or more server(s) 104. The server(s) 104 can be hardware and/or software (e.g., threads, processes, or computing systems). One possible communication between a client 102 and a server 104 can be in the form of a data packet adapted to be transmitted between two or more computer processes. The networking environment 100 includes a communication framework 106 that can be employed to facilitate communications between the client(s) 102 and the server(s) 104.

FIG. 2 is a block diagram of a computing environment 200 that may be used to implement a system and method for remotely navigating a display of a target computing device using a screen of a source computing device. The computing environment 200 includes a computer 202. The computer 202 includes a processing unit 204, a system memory 206, and a system bus 208. The system bus 208 couples system components including, but not limited to, the system memory 206 to the processing unit 204. The processing unit 204 can be any of various available processors. Dual microprocessors and other multiprocessor architectures also can be employed as the processing unit 204.

The system bus 208 can be any of several types of bus structures, including the memory bus or memory controller, a peripheral bus or external bus, or a local bus using any variety of available bus architectures known to those of ordinary skill in the art. The system memory 206 is computer-readable storage media that includes volatile memory 210 and non-volatile memory 212. The basic input/output system (BIOS), containing the basic routines to transfer information between elements within the computer 202, such as during start-up, is stored in non-volatile memory 212. By way of illustration, and not limitation, non-volatile memory 212 can include read-only memory (ROM), programmable ROM (PROM), electrically-programmable ROM (EPROM), electrically-erasable programmable ROM (EEPROM), or flash memory.

Volatile memory 210 includes random access memory (RAM), which acts as external cache memory. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 202 also includes other computer-readable storage media, such as removable/non-removable, volatile/non-volatile computer storage media. FIG. 2 shows, for example, a disk storage 214. Disk storage 214 may include, but is not limited to, a magnetic disk drive, floppy disk drive, tape drive, Jaz drive, Zip drive, LS-100 drive, flash memory card, or memory stick.

In addition, disk storage 214 can include storage media separately or in combination with other storage media including, but not limited to, an optical disk drive such as a compact disk ROM device (CD-ROM), CD recordable drive (CD-R Drive), CD rewritable drive (CD-RW Drive), or a digital versatile disk ROM drive (DVD-ROM). To facilitate connection of the disk storage 214 to the system bus 208, a removable or non-removable interface is typically used, such as interface 216.

It is to be appreciated that FIG. 2 describes software that acts as an intermediary between users and the basic computer resources described in the computing environment 200. Such software includes an operating system 218. The operating system 218, which can be stored on disk storage 214, acts to control and allocate resources of the computer 202.

System applications 220 take advantage of the management of resources by the operating system 218 through program modules 222 and program data 224 stored either in system memory 206 or on disk storage 214. It is to be appreciated that the claimed subject matter can be implemented with various operating systems or combinations of operating systems.

A user enters commands or information into the computer 202 through input devices 226. Input devices 226 can include, but are not limited to, a pointing device (such as a mouse, trackball, stylus, or the like), a keyboard, a microphone, a gesture or touch input device, a voice input device, a joystick, a satellite dish, a scanner, a TV tuner card, a digital camera, a digital video camera, a web camera, or the like. The input devices 226 connect to the processing unit 204 through the system bus 208 via interface port(s) 228. Interface port(s) 228 can include, for example, a serial port, a parallel port, a game port, and a universal serial bus (USB). Output device(s) 230 may also use the same types of ports as input device(s) 226. Thus, for example, a USB port may be used to provide input to the computer 202 and to output information from the computer 202 to an output device 230.

An output adapter 232 is provided to illustrate that there are some output devices 230 like monitors, speakers, and printers, among other output devices 230, which are accessible via the output adapters 232. The output adapters 232 include, by way of illustration and not limitation, video and sound cards that provide a means of connection between the output device 230 and the system bus 208. It can be noted that other devices and/or systems of devices provide both input and output capabilities, such as remote computer(s) 234.

The computer 202 may be a server within a networking environment (e.g., the networking environment 100), and may include logical connections to one or more remote computers, such as remote computer(s) 234. The remote computer(s) 234 may be client systems configured with web browsers, PC applications, mobile phone applications, and the like. The remote computer(s) 234 can be a personal computer, a server, a router, a network PC, a workstation, a microprocessor based appliance, a mobile phone, a peer device or other common network node and the like, and typically includes many or all of the elements described relative to the computer 202. For purposes of brevity, the remote computer(s) 234 are illustrated with a memory storage device 236. The remote computer(s) 234 are logically connected to the computer 202 through a network interface 238, and physically connected to the computer 202 via a communication connection 240.

Network interface 238 encompasses wired and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 240 refers to the hardware and/or software employed to connect the network interface 238 to the system bus 208. While communication connection 240 is shown for illustrative clarity inside the computer 202, it can also be external to the computer 202. The hardware and/or software for connection to the network interface 238 may include, for example, internal and external technologies such as mobile phone switches, modems including regular telephone grade modems, cable modems and DSL modems, ISDN adapters, and Ethernet cards.

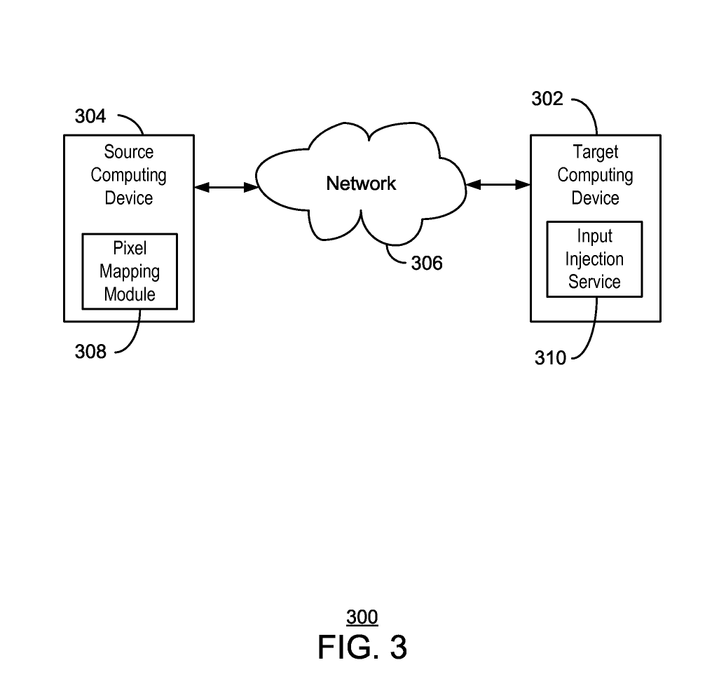

Furthermore, in various embodiments, the computer 202 may be a source computing device, and the remote computer(s) 234 may be target computing devices that are communicably coupled to the computer 202 via the network interface 238. According to such embodiments, a screen of the computer 202 may be used to remotely navigate a display of any of the remote computer(s) 234, as discussed further with respect to FIGS. 3-6.

FIG. 3 is a block diagram of a system 300 for remotely navigating a display of a target computing device 302 using a screen of a source computing device 304. The target computing device 302 may be any suitable type of computing device including a display, such as a laptop computer, desktop computer, server, tablet computer, gaming system, mobile computing device, or the like. The display may be a monitor, touchscreen, or the like. Further, the source computing device 304 may be any suitable type of computing device that includes a screen, such as a touchscreen or other type of screen that utilizes a pen, stylus, mouse, or the like for navigation. For example, the source computing device 304 may be a mobile phone or tablet computer, among others. In various embodiments, it is assumed that the user of the source computing device 304 is able to see the display of the target computing device 302.

As shown in FIG. 3, the system 300 includes a network 306 that communicably couples the target computing device 302 to the source computing device 304. In addition, the source computing device 304 includes a pixel mapping module 308. The pixel mapping module 308 may be any suitable type of application, service, or computer-readable medium that allows the source computing device 304 to remotely navigate the display of the target computing device 302 by sending information relating to a source input on the screen of the source computing device 304 to the target computing device 302 via the network 306. Such information may include a target input to be applied to the display of the target computing device 302 that corresponds to the source input applied to the screen of the source computing device 304. In addition, in some embodiments, the pixel mapping module 308 may allow the source computing device 304 to function as an input device of the target computing device 302, such as a pointing device or keyboard.

Furthermore, the target computing device 302 includes an input injection service 310. The input injection service 310 may receive the information relating to the source input on the screen of the source computing device 304, and may inject such information into the target computing device 302. In various embodiments, the input injection service 310 may be any suitable type of application or service residing within the target computing device 302. The input injection service 310 may continuously monitor the target computing device 302 to determine whether any information relating to a source input has been received from a source computing device via the network 306.

According to embodiments described herein, the source computing device 304 remotely navigates the display of the target computing device 302 using a number of navigation jump points that are positioned on the screen of the source computing device 304. Specifically, the navigation jump points may provide a combination of absolute pixel mapping and relative pixel mapping for remotely navigating the display of the target computing device 302 using the screen of the source computing device 304. In various embodiments, the use of such navigation jump points allows the smaller screen to be elegantly mapped to the larger display, while still maintaining pixel for pixel accuracy.

In various embodiments, the navigation jump points are used to partition the screen of the source computing device 304. Each navigation jump point corresponds to an absolute pixel mapping value on the display of the target computing device 302. Therefore, when the user of the source computing device 304 provides a source input by touching the screen at a particular point or using a pen or mouse to activate the screen at a particular point, for example, the source computing device 304 determines whether the source input is associated with a navigation jump point on the screen of the source computing device 304. If the source input is not associated with a navigation jump point, the source computing device 304 simply translates the source input into the corresponding relative pixel mapping value on the display of the target computing device 302. However, if the source input is associated with a navigation jump point, the source computing device 304 translates the source input into the corresponding absolute pixel mapping value on the display of the target computing device 302. In addition, the source computing device 304 may translate any continuation of the source input with the screen of the source computing device 304 into a corresponding relative pixel mapping value, thus providing pixel for pixel accuracy between the screen of the source computing device 304 and the display of the target computing device 302.

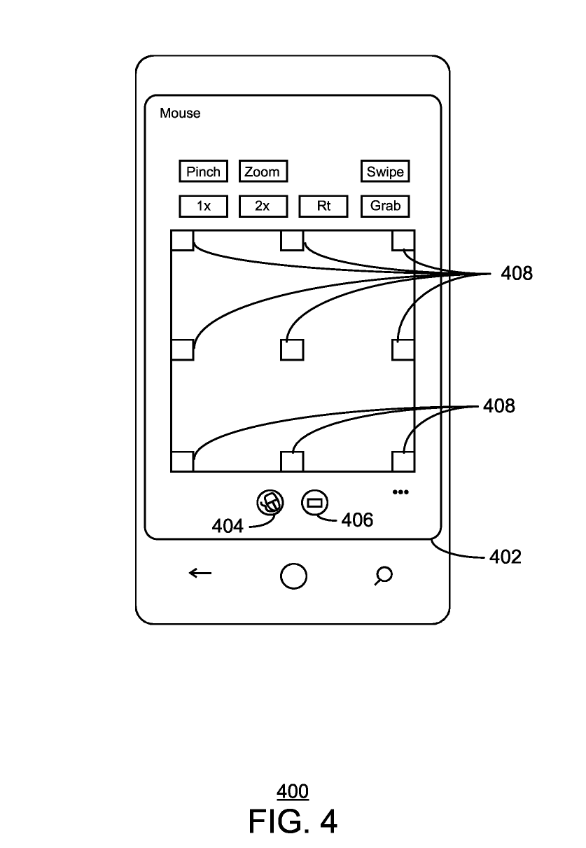

Any number of navigation jump points may be used to partition the screen of the source computing device 304. For example, in various embodiments, a nine navigation jump point layout is used, wherein the nine navigation jump points are positioned in the top left, top middle, top right, center left, center middle, center right, bottom left, bottom middle, and bottom right of the screen. This layout is discussed further with respect to FIG. 4. In other embodiments, an eight navigation jump point layout is used, wherein the eight navigation jump points are positioned in the top left, top middle, top right, center left, center right, bottom left, bottom middle, and bottom right of the screen. In other embodiments, a five navigation jump point layout is used, wherein the five navigation jump points are positioned in the top left, top right, center middle, bottom left, and bottom right of the screen. In addition, a different five navigation jump point layout may be used, wherein the five navigation jump points are positioned in the top middle, center left, center middle, center right, and bottom middle of the screen. In still other embodiments, a four navigation jump point layout is used, wherein the four navigation jump points are positioned in the top left, top right, bottom left, and bottom right of the screen. A different four navigation jump point layout may also be used, wherein the four navigation jump points are positioned in the top middle, center left, center right, and bottom middle of the screen. Furthermore, in some embodiments, a layout in which the navigation jump points are located off the edges of the screen but still in the same relative cardinal locations may be used.

In various embodiments, the size of each navigation jump point on the screen of the source computing device 304 may be configured based on the details of the specific implementation. For example, in some embodiments, the navigation jump points are set to a default of forty pixels in height and forty pixels in width. Such a default size may be adequate to accommodate the average finger size.

FIG. 4 is a schematic of a mobile phone 400 including a touchscreen 402 that may be used to remotely navigate a display of a target computing device. In various embodiments, the mobile phone 400 may be communicably coupled to the target computing device, and may be configured to function as an input device of the target computing device. Specifically, if the user of the mobile phone 400 touches a mouse icon 404 on the touchscreen 402, the mobile phone 400 may function as the mouse of the target computing device. Alternatively, if the user of the mobile phone 400 touches a keyboard icon 406 on the touchscreen 402, the mobile phone 400 may function as the keyboard of the target computing device.

If the touchscreen 402 of the mobile phone 400 is functioning as the mouse of the target computing device, the touchscreen 402 may display a number of navigation jump points 408. For example, the touchscreen 402 may display nine navigation jump points 408 according to the nine navigation jump point layout described above. Furthermore, as discussed above, when the user of the mobile phone 400 touches the touchscreen 402 at a particular navigation jump point 408, the touch input may be translated into a corresponding absolute pixel mapping value on the display of the target computing device. In addition, any continuation of the user's touch on the touchscreen 402 may be translated into a corresponding relative pixel mapping value on the display of the target computing device.

In various embodiments, specific touch events on the touchscreen 402 of the mobile phone 400 may be translated to corresponding mouse functions on the display of the target computing device. For example, a single tap on the touchscreen 402 may correspond to a single click on the mouse, a double tap on the touchscreen 402 may correspond to a double click on the mouse, and a tap and hold on the touchscreen 402 may correspond to a right click on the mouse. Furthermore, specific touch events on the touchscreen 402 may result in the activation of a gesture function, such as a pinch function or a zoom function, for example, on the display of the target computing device.

Furthermore, the navigation jump points 408 may naturally map to specialized functionalities of the target computing device. For example, contacting a specific navigation jump point 408 may cause the properties of an application executing on the target computing device to be displayed, or may cause an application that was previously executing on the target computing device to be reactivated. As another example, contacting a specific navigation jump point 408 may cause a particular menu, bar, or item to be displayed on the display of the target computing device. Moreover, the specialized functionality may also include any other functionality supported by the mobile phone 400.

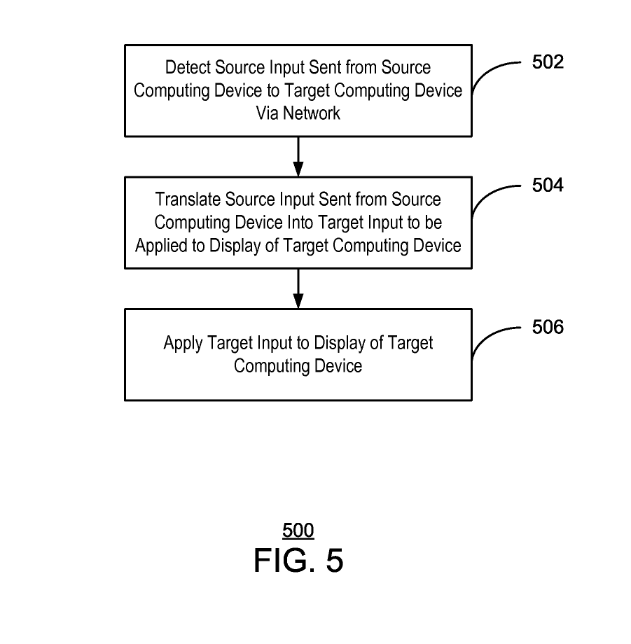

FIG. 5 is a process flow diagram of a method 500 for translating a source input on a screen of a source computing device into a target input to be applied to a display of a target computing device. The method 500 begins at block 502 with the detection of a source input sent from the source computing device to the target computing device via the network. Specifically, the source input may be applied to the screen of the source computing device.

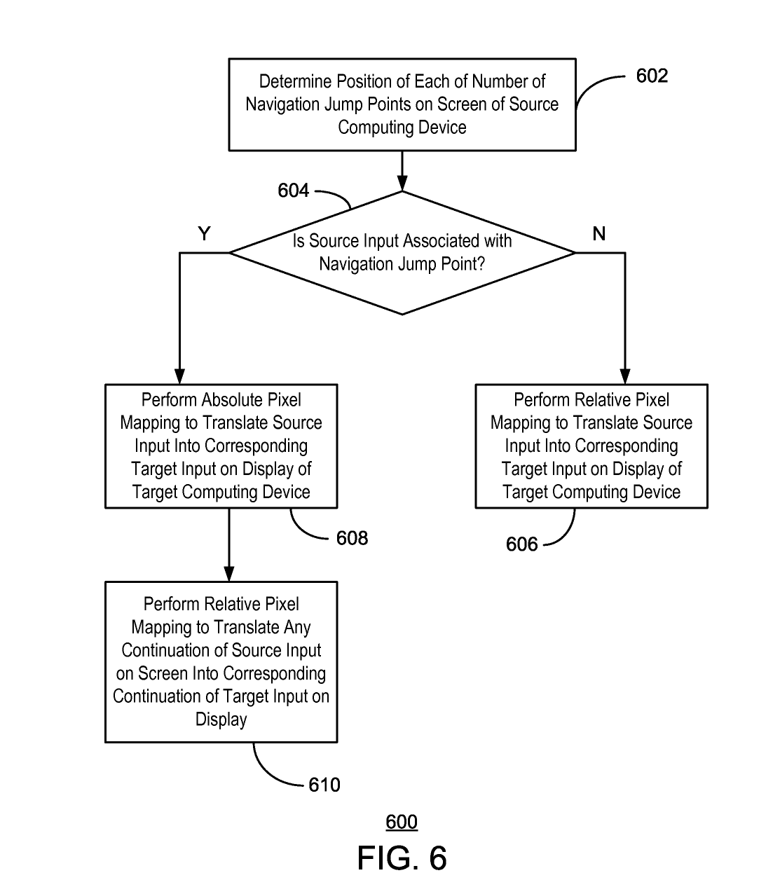

At block 504, the source input sent from the source computing device is translated into a target input to be applied to the display of the target computing device. At block 506, the target input is applied to the display of the target computing device. According to embodiments described herein, applying the target input includes remotely navigating the display of the target computing device based on a combination of absolute pixel mapping and relative pixel mapping with relation to the screen of the source computing device, as discussed further with respect to FIG. 6. Furthermore, in various embodiments, an input injection service executing on the target computing device is configured to inject the target input corresponding to the source input into the target computing device.

In various embodiments, the source computing device may function as the pointing device, e.g., mouse, of the target computing device. If the source computing device is functioning as the mouse of the target computing device, a touch event corresponding to the source input may be translated into a function of the mouse of the target computing device. For example, a touch event including a single tap may correspond to a single click on the mouse, a touch event including a double tap may correspond to a double click on the mouse, and a touch event including a tap and hold may correspond to a right click on the mouse. Furthermore, the touch event may include the activation of any suitable type of standard, e.g., system-defined, or custom gesture function that is known by the source computing device, provided that an equivalent gesture function is supported by the target computing device or, more specifically, supported by the input injection service executing on the target computing device.

The process flow diagram of FIG. 5 is not intended to indicate that the blocks of the method 500 are to be executed in any particular order, or that all of the blocks are to be included in every case. Further, any number of additional blocks not shown in FIG. 5 may be included within the method 500, depending on the details of the specific implementation.

FIG. 6 is a process flow diagram of a method 600 for remotely navigating a display of a target computing device using a screen of a source computing device. In various embodiments, the method 600 corresponds to blocks 504 and 506 of the method 500 of FIG. 5. The method 600 begins at block 602 with the determination of the position of each of a number of navigation jump points on a screen of the source computing device. As discussed above, the screen may include any number of navigation jump points arranged in any suitable type of navigation jump point layout, depending on the details of the specific implementation.

At block 604, it is determined whether the source input is associated with a navigation jump point. This may be determined based on the position at which the source input is applied to the screen. If it is determined that the source input is not associated with a navigation jump point at block 604, relative pixel mapping is performed at block 606 to translate the source input on the screen into a corresponding target input on the display.

Alternatively, if it is determined that the source input is associated with a navigation jump point at block 604, absolute pixel mapping is performed at block 608 to translate the source input into a corresponding target input on a display of a target computing device based on the navigation jump point with which the source input is associated. In various embodiments, the navigation jump point with which the source input is associated may be the first navigation jump point at which force is applied to the screen via the source input. In addition, relative pixel mapping is performed at block 610 to translate any continuation of the source input on the screen into a corresponding continuation of the target input on the display.

The process flow diagram of FIG. 6 is not intended to indicate that the blocks of the method 600 are to be executed in any particular order, or that all of the blocks are to be included in every case. Further, any number of additional blocks not shown in FIG. 6 may be included within the method 600, depending on the details of the specific implementation.

In some embodiments, any of the navigation jump points may be mapped to a specialized functionality corresponding to the target computing device based on the position of each navigation jump point on the screen of the source computing device. For example, applying to source input to a specific navigation jump point may cause the properties of an application executing on the target computing device to be displayed, or may cause an application that was previously executing on the target computing device to be reactivated. As another example, applying the source input to a specific navigation jump point may cause a particular menu, bar, or item to be displayed on the display of the target computing device. Moreover, the specialized functionality may also include any other functionality that is supported by the source computing device and the target computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for remotely navigating a display of a target computing device using a screen of a source computing device, comprising:
detecting a source input on a screen of a source computing device;
determining a position of each of a plurality of navigation jump points on the screen;
determining whether the source input is associated with a navigation jump point;
if the source input is not associated with a navigation jump point, performing relative pixel mapping to translate the source input on the screen into a corresponding target input on a display of a target computing device; and
if the source input is associated with a navigation jump point, performing absolute pixel mapping to translate the source input into a corresponding target input on the display based on the navigation jump point with which the source input is associated, and performing relative pixel mapping to translate any continuation of the source input on the screen into a corresponding continuation of the target input on the display.

2. The method of claim 1, comprising mapping any of the plurality of navigation jump points to a specialized functionality corresponding to the target computing device based on a position of the plurality of navigation jump points on the screen of the source computing device.

3. The method of claim 2, comprising mapping a navigation jump point to a specialized functionality that comprises displaying properties of an application executing on the target computing device.

4. The method of claim 2, comprising mapping a navigation jump point to a specialized functionality that comprises displaying a specialized menu.

5. The method of claim 2, comprising mapping a navigation jump point to a specialized functionality that comprises reactivating an application that was previously executing on the target computing device.

6. The method of claim 1, comprising translating a touch event corresponding to the source input into a function of a mouse of the target computing device.

7. The method of claim 6, wherein the touch event comprises a single tap on the screen, and wherein the function of the mouse comprises a single click on the mouse.

8. The method of claim 6, wherein the touch event comprises a double tap on the screen, and wherein the function of the mouse comprises a double click on the mouse.

9. The method of claim 6, wherein the touch event comprises a tap and hold on the screen, and wherein the function of the mouse comprises a right click on the mouse.

10. The method of claim 6, wherein the touch event comprises an activation of a gesture function on the display of the target computing device.

11. The method of claim 10, wherein the gesture function comprises a zoom function.

12. The method of claim 10, wherein the gesture function comprises a pinch function.

13. A system for remotely navigating a display of a target computing device using a screen of a source computing device, comprising:
a target computing device comprising a display;
a network for communicably coupling the target computing device to a source computing device; and
the source computing device comprising:
a screen, wherein the screen comprises a plurality of navigation jump points,
a processor that is adapted to execute stored instructions; and
a system memory comprising code configured to:
detect a source input on the screen;
determine whether the source input is associated with a navigation jump point based on a position at which the source input is applied to the screen;
if the source input is not associated with a navigation jump point, perform relative pixel mapping to translate the source input on the screen into a corresponding target input on the display of the target computing device; and
if the source input is associated with a navigation jump point, perform absolute pixel mapping to translate the source input on the screen into a corresponding target input on the display based on the navigation jump point with which the source input is associated, and perform relative pixel mapping to translate any continuation of the source input on the screen into a corresponding continuation of the target input on the display.

14. The system of claim 13, wherein the target computing device comprises an input injection service configured to inject the target input corresponding to the source input into the target computing device.

15. The system of claim 13, wherein the source computing device functions as a pointing device of the target computing device.

16. The system of claim 13, wherein the screen of the source computing device comprises a touchscreen, and wherein the source input comprises a touch input.

17. The system of claim 13, wherein the system memory comprises code configured to map any of the plurality of navigation jump points to a specialized functionality corresponding to the target computing device based on a position of the plurality of navigation jump points on the screen of the source computing device.

18. The system of claim 13, wherein the source computing device functions as a keyboard of the target computing device.

19. One or more computer-readable storage media for storing computer-readable instructions, the computer-readable instructions providing a system for remotely navigating a display of a target computing device using a screen of a source computing device when executed by one or more processing devices, the computer-readable instructions comprising code configured to:
detect a source input sent from the source computing device to the target computing device via a network;
determine a position of each of a plurality of navigation jump points on the screen of the source computing device;
determine whether the source input is associated with a navigation jump point based on a position at which the source input is applied to the screen;
if the source input is not associated with a navigation jump point, perform relative pixel mapping to translate the source input on the screen into a corresponding target input on the display of the target computing device; and
if the source input is associated with a navigation jump point, perform absolute pixel mapping to translate the source input on the screen into a corresponding target input on the display based on the navigation jump point with which the source input is associated, and perform relative pixel mapping to translate any continuation of the source input on the screen into a corresponding continuation of the target input on the display.

20. The one or more computer-readable storage media of claim 19, wherein the computer-readable instructions comprise code configured to map any of the plurality of navigation jump points to a specialized functionality corresponding to the target computing device based on a position of the plurality of navigation jump points on the screen of the source computing device.
